(19) United States
(12) Patent Application Publication
(10) Pub. No.: US 2018/0074679 A1
(43) Pub. Date: Mar. 15, 2018

(54) METHOD, APPARATUS, AND SYSTEM FOR SHARING VIRTUAL REALITY VIEWPORT

(71) Applicant: SAMSUNG ELECTRONICS CO., LTD., Suwon-si (KR)

(72) Inventors: Minghao WANG, Nanjing (CN); Ming LIU, Nanjing (CN); Youxin CHEN, Nanjing (CN); Zhangliang XIONG, Nanjing (CN)

(73) Assignee: SAMSUNG ELECTRONICS CO., LTD., Suwon-si (KR)

(21) Appl. No.: 15/703,467

(22) Filed: Sep. 13, 2017

(30) Foreign Application Priority Data
Sep. 14, 2016 (CN) 201610826631.8

(51) Int. Cl. G06F 3/0481; G06F 3/0484; G06F 3/14; G06F 3/01; G02B 27/01; G06T 19/00

(52) U.S. Cl. CPC G06F 3/04815; G06F 3/0484; G06F 3/1454; G06T 19/003; G06F 3/04812; G02B 27/0172; G06F 3/011

(57) ABSTRACT

The present disclosure discloses a method, apparatus, and system for sharing a virtual reality (VR) viewport. The method may include: establishing, by a content distribution server, a first transport connection; receiving, by the viewport sharing server, panoramic video data; establishing, by the viewport sharing server, a second transport connection for receiving first viewport information supplied by the terminal or transmitting second viewport information to the terminal; rendering, by the viewport sharing server, the received viewport information; receiving, by the terminal, the panoramic video data; converting, by the terminal, the panoramic video data into first video data; rendering, by the terminal, a first video within the user viewport scope; receiving, by the terminal, the second viewport information; converting, by the terminal, the panoramic video data into second video data corresponding to the second viewport information; and rendering, by the terminal, a second video corresponding to the second viewport information.

### CROSS-REFERENCE TO RELATED APPLICATION

This application claims priority from a Chinese Patent Application Serial No. 201610826631.8, filed on Sep. 14, 2016 in the State Intellectual Property Office (SIPO) of the People's Republic of China, the entire disclosure of which is incorporated herein by reference.

### BACKGROUND

### 1. Field

The present disclosure relates generally to the field of communication among electronic devices, in particular to the field of communication among virtual reality devices, and more particularly, to a method, apparatus, and system for sharing a virtual reality viewport.

### 2. Description of the Related Art

With the development of virtual reality (VR) technologies, panoramic video and relevant technologies are attracting extensive attention. Panoramic video, also referred to as 360° panoramic video, is formed by a series of panoramic images. Due to the limitation of photographing devices, a plurality of cameras are required to capture images from a plurality of viewpoints concurrently, and then the images of different viewpoints but captured at the same time are stitched together through a stitching algorithm to obtain a panoramic image.

A viewport is a polygonal viewing region in computer graphics. However, the shape of the region is not limited to the polygon. The viewport of the VR device refers to a display region for actually displaying the converted image in the rendering process. The information for rendering the panoramic video data and generating an image to be displayed in the viewport of the VR device may be referred to as viewport information or simply a viewport for short. When a user terminal presents to the user an image of an area that is visible from a viewport of a user, the image cannot be displayed directly, because a 360° image is displayed in a panoramic video and lines in the image are distorted to some extent. Therefore, different coordinate transformation formulas need to be selected depending on different projection methods, for transforming three-dimensional coordinates into two-dimensional coordinates in order to obtain the image of the area that is visible from the viewport of the user. In this way, the image of the area that is visible from the viewport of the user can be displayed. Because the user is allowed to view a panoramic video from different viewpoints and positions, different users may have different viewports of a same virtual scene.

However, traditionally the image displayed to the user only includes the image of the area that is visible from the viewport of the user. That is, information volume available to the user is relatively small. Consequently, information volume that may be exchanged between a user and other users or the administrator is relatively small.

### SUMMARY

The present disclosure provides a method, apparatus, and system for sharing a

VR viewport.

According to an aspect of an example embodiment, a method for sharing a VR viewport is provided. The method may include: establishing, by a content distribution server, a first transport connection to a terminal and a viewport sharing server for multicasting panoramic video data to the terminal and the viewport sharing server; receiving, by the viewport sharing server, the panoramic video data from the content distribution server through the first transport connection; establishing, by the viewport sharing server, a second transport connection to the terminal for at least one of receiving first viewport information supplied by the terminal and transmitting second viewport information to the terminal; rendering, by the viewport sharing server, the first viewport information; receiving, by the terminal, the panoramic video data from the content distribution server through the first transport connection; converting, by the terminal, the panoramic video data into first video data based on a user viewport scope; rendering, by the terminal, a first video within the user viewport scope based on the first video data; supplying, by the terminal, the first viewport information of the terminal to the viewport sharing server through the second transport connection, and receiving the second viewport information transmitted from the viewport sharing server; converting, by the terminal, the panoramic video data into second video data corresponding to the second viewport information; and rendering, by the terminal, a second video corresponding to the second viewport information based on the second video data.

The supplying, by the terminal, the first viewport information of the terminal may include: supplying, by the terminal, the first viewport information, which indicates that sharing flag information has been set to a predetermined value, to the viewport sharing server in response to a user setting the sharing flag information to the predetermined value. In addition, the transmitting, by the viewport sharing server, viewport information to the terminal may include: transmitting, by the viewport sharing server, the second viewport information, which indicates that the sharing flag information has been set to the predetermined value, to another terminal in a network in response to the viewport sharing server receiving the first viewport information from the terminal.

The method may further include: transmitting to the viewport sharing server, by the terminal, a request for acquiring the second viewport information received by the viewport sharing server and receiving, at the terminal, only the second viewport information transmitted from the viewport sharing server in response to the request in response to a viewport sharing mode set by a user being a viewport tracking mode for the viewport sharing server.

The method may further include: transmitting to the viewport sharing server, by the terminal, a request for acquiring viewport information of another terminal, and receiving the second viewport information of the another terminal transmitted from the viewport sharing server in response to the request in response to a viewport sharing mode set by a user being a viewport tracking mode for the another terminal.

The method may further include: stopping, by the terminal, receiving the second viewport information transmitted from the viewport sharing server in response to a viewport sharing mode set by a user being a do not disturb (DND) mode.

The rendering, by the terminal, the first video and the rendering, by the terminal, the second video may include: rendering, by the terminal, one video of the first video and the second video in an inset window inside of another video of the first video and the second video, in response to a rendering mode set by a user being a picture-in-picture (PIP) mode; or rendering, by the terminal, the second video corresponding to the second viewport information in a full screen mode in response to the rendering mode set by the user being the full screen mode.

The transmitting, by the viewport sharing server, the second viewport information to the terminal may include: transmitting, by the viewport sharing server, the second viewport information received by the viewport sharing server to another terminal in a network.

The method may further include: rendering, by the viewport sharing server, a third video corresponding to the received viewport information based on the panoramic video data and the first viewport information; or rendering, by the viewport sharing server, a fourth video corresponding to the received viewport information based on the panoramic video data and the first viewport information in response to receiving a selection operation of the first viewport information rendered by the viewport sharing server.

The first viewport information or the second viewport information may include at least one of: a pitch angle of a viewport, a yaw angle of the viewport, sharing flag information, and viewport owner information.

According to an aspect of an example embodiment, a method for sharing a VR viewport is provided. The method may include: establishing a first transport connection to a content distribution server; receiving, through the first transport connection, panoramic video data multicast by the content distribution server; establishing a second transport connection to a terminal; receiving, through the second transport connection, first viewport information supplied by the terminal; transmitting, through the second transport connection, second viewport information to the terminal; and rendering the received viewport information.

The transmitting, through the second transport connection, the second viewport information to the terminal may include: transmitting, through the second transport connection, the second viewport information, which indicates that sharing flag information has been set to a predetermined value, to another terminal in a network.

In some implementations, the transmitting, through the second transport connection, the second viewport information to the terminal may include at least one of the following: transmitting, in response to reception of a first request transmitted from the terminal, only the first viewport information received by a viewport sharing server to the terminal through the second transport connection, wherein the first request is for acquiring the first viewport information received by the viewport sharing server and is transmitted from the terminal to the viewport sharing server in response to a viewport sharing mode set by a user being a first viewport tracking mode for the viewport sharing server; and transmitting, in response to reception of a second request transmitted from the terminal, the second viewport information of another terminal to the terminal through the second transport connection, wherein the second request is for acquiring the second viewport information of the another terminal and is transmitted from the terminal to the viewport sharing server in response to the viewport sharing mode set by the user being a second viewport tracking mode for the another terminal.

The transmitting, through the second transport connection, the second viewport information to the terminal may include: transmitting, through the second transport connection, the first viewport information received by a viewport sharing server to another terminal in a network.

The method may further include: rendering a video corresponding to the first viewport information based on the panoramic video data and the first viewport information; or rendering, in response to reception of a selection operation to the rendered received viewport information, the video corresponding to the first received viewport information based on the panoramic video data and the first viewport information.

According to an aspect of an example embodiment, a method for sharing a VR viewport is provided. The method may include: establishing a first transport connection to a content distribution server; receiving panoramic video data through the first transport connection; converting the panoramic video data into first video data based on a user viewport scope, and rendering a first video within the user viewport scope based on the first video data; establishing a second transport connection to a viewport sharing server; supplying first viewport information of the terminal through the second transport connection; receiving second viewport information transmitted from the viewport sharing server; and converting the panoramic video data into second video data corresponding to the second viewport information, and rendering a second video corresponding to the second viewport information.

The supplying the first viewport information of the terminal through the second transport connection may include: supplying, through the second transport connection, the first viewport information, which indicates that sharing flag information has been set to a predetermined value, to the viewport sharing server in response to a user setting the sharing flag information to the predetermined value.

The method may further include: in response to a viewport sharing mode set by a user being a first viewport tracking mode for the viewport sharing server, transmitting to the viewport sharing server, through the second transport connection, a first request for acquiring the second viewport information received by the viewport sharing server, and receiving the second viewport information transmitted from the viewport sharing server in response to the first request; or, in response to the viewport sharing mode set by the user being a second viewport tracking mode for the terminal, transmitting to the viewport sharing server, through the second transport connection, a second request for acquiring the second viewport information of another terminal, and receiving the second viewport information of the another terminal transmitted from the viewport sharing server in response to the second request.

The method may further include: stopping, in response to a viewport sharing mode set by a user being a DND mode, receiving the second viewport information transmitted from the viewport sharing server.

The method may further include: rendering one video of the first video and the second video in an inset window inside of another video of the first video and the second video, in response to a rendering mode set by a user being a PIP mode; or rendering the second video corresponding to the second viewport information in a full screen mode in response to the rendering mode set by the user being the full screen mode.

According to an aspect of an example embodiment, a system for sharing a VR viewport is provided. The system may include: a terminal; a content sharing server; and a content distribution server configured to establish a first transport connection to the terminal and the viewport sharing server for multicasting panoramic video data. The viewport sharing server may be configured to: receive the panoramic video data from the content distribution server, establish a second transport connection to the terminal to receive first viewport information supplied by the terminal or transmit second viewport information to the terminal, and render the first viewport information. The terminal may be configured to: receive the panoramic video data from the content distribution server, convert the panoramic video data into first video data based on a user viewport scope, render a first video within the user viewport scope based on the first video data, supply the first viewport information of the terminal to the viewport sharing server, and receive the second viewport information transmitted from the viewport sharing server, convert the panoramic video data into second video data corresponding to the second viewport information, and render a second video corresponding to the second viewport information based on the second video data.

The terminal may be further configured to supply the first viewport information, which indicates that sharing flag information has been set to a predetermined value, to the viewport sharing server in response to a user setting the sharing flag information to the predetermined value. In addition, the viewport sharing server may be further configured to transmit the second viewport information, which indicates that the sharing flag information has been set to the predetermined value, to another terminal in a network in response to the viewport sharing server receiving the first viewport information from the terminal.

The terminal may be further configured to transmit to the viewport sharing server, in response to a viewport sharing mode set by a user being a viewport tracking mode for the viewport sharing server, a request for acquiring the second viewport information received by the viewport sharing server, and receive only the second viewport information transmitted from the viewport sharing server in response to the request.

The terminal may be further configured to transmit to the viewport sharing server, in response to a viewport sharing mode set by a user being a viewport tracking mode for another terminal, a request for acquiring viewport information of the another terminal, and receive the second viewport information of the another terminal transmitted from the viewport sharing server in response to the request.

The terminal may be further configured to stop receiving the second viewport information transmitted from the viewport sharing server in response to a viewport sharing mode set by a user being a DND mode.

The terminal may be further configured to: render one video of the first video and the second video in an inset window inside of another video of the first video and the second video, in response to if a rendering mode set by a user being a PIP mode; or render the second video corresponding to the second viewport information in a full screen mode in response to the rendering mode set by the user being the full screen mode.

The viewport sharing server may be further configured to transmit the second viewport information received by the viewport sharing server to another terminal in a network.

The viewport sharing server may be further configured to: render a third video corresponding to the received viewport information based on the panoramic video data and the first viewport information; or render, in response to receiving a selection operation of the first viewport information rendered by the viewport sharing server, a fourth video corresponding to the received viewport information based on the panoramic video data and the first viewport information.

According to an aspect of an example embodiment, an apparatus for sharing a VR viewport is provided. The apparatus may include: a first transport connector configured to establish a first transport connection to a content distribution server; a video receiver configured to receive, through the first transport connection, panoramic video data multicast by the content distribution server; a second transport connector configured to establish a second transport connection to a terminal; a viewport receiver configured to receive, through the second transport connection, first viewport information supplied by the terminal; a viewport transmitter configured to transmit, through the second transport connection, second viewport information to the terminal; and a renderer configured to render the received viewport information.

The viewport transmitter may be further configured to transmit the second viewport information, which indicates that sharing flag information has been set to a predetermined value, to another terminal in a network.

The viewport transmitter may be further configured to perform at least one of the following: transmitting, in response to reception of a first request transmitted from the terminal, only the first viewport information received by a viewport sharing server to the terminal, wherein the first request is for acquiring the first viewport information received by the viewport sharing server and is transmitted from the terminal to the viewport sharing server in response to a viewport sharing mode set by a user being a first viewport tracking mode for the viewport sharing server; and transmitting, in response to reception of a second request transmitted from the terminal, the second viewport information of another terminal to the terminal, wherein the second request is for acquiring the second viewport information of the another terminal and is transmitted from the terminal to the viewport sharing server in response to the viewport sharing mode set by the user being a second viewport tracking mode for the another terminal.

The viewport transmitter may be further configured to transmit the first viewport information received by a viewport sharing server to a terminal in another network.

The rendering module may be further configured to: render a video corresponding to the first viewport information based on the panoramic video data and the first viewport information; or render, in response to reception of a selection operation to the rendered received viewport information, the video corresponding to the first viewport information based on the panoramic video data and the first viewport information.

According to an aspect of an example embodiment, an apparatus for sharing a VR viewport is provided. The apparatus may include: a first transport connector configured to establish a first transport connection to a content distribution server; a video receiver configured to receive panoramic video data through the first transport connection; a second transport connector configured to establish a second transport connection to a viewport sharing server; a viewport sharer configured to supply first viewport information of a terminal through the second transport connection; a viewport receiver configured to receive second viewport information transmitted from the viewport sharing server; and a renderer configured to: convert the panoramic video data into first video data based on a user viewport scope, render a first video within the user viewport scope based on the first video data, convert the panoramic video data into second video data corresponding to the second viewport information, and render a second video corresponding to the second viewport information.

The viewport sharer may be further configured to supply, through the second transport connection, the first viewport information, which indicates that sharing flag information has been set to a predetermined value, to the viewport sharing server in response to a user setting the sharing flag information to the predetermined value.

The apparatus may further include: a viewport tracker configured to, in response to a viewport sharing mode set by a user being a first viewport tracking mode for the viewport sharing server, transmit to the viewport sharing server a first request for acquiring the second viewport information received by the viewport sharing server; or, in response to the viewport sharing mode set by the user being a second viewport tracking mode for another terminal, transmit to the viewport sharing server a second request for acquiring the second viewport information of the another terminal. In addition, the viewport receiver may be further configured to: receive the second viewport information transmitted from the viewport sharing server in response to the first request; or receive the second viewport information of the another terminal transmitted from the viewport sharing server in response to the second request.

The renderer may be further configured to stop, in response to a viewport sharing mode set by a user being a DND mode, receiving the second viewport information transmitted from the viewport sharing server.

The renderer may be further configured to: render one video of the first video and the second video in an inset window inside of another video of the first video and the second video, in response to a rendering mode set by a user being a PIP mode; or render the second video corresponding to the second viewport information in a full screen mode in response to the rendering mode set by the user being the full screen mode.

According to the method, apparatus and system for sharing a VR viewport provided by the present disclosure, the content distribution server may establish first transport connections to the terminal and the viewport sharing server, respectively, to multicast panoramic video data to the terminal and the viewport sharing server; the viewport sharing server may establish the first transport connection to the content distribution server to receive the panoramic video data, establish a second transport connection to the terminal to receive viewport information supplied by the terminal or transmit viewport information to the terminal, and render the received viewport information; and the terminal may establish the first transport connection to the content distribution server to receive the panoramic video data, convert the panoramic video data into video data within a user viewport scope, render a video within the user viewport scope, establish a second transport connection to the viewport sharing server to supply the viewport information of the terminal and receive the viewport information transmitted from the viewport sharing server, convert the panoramic video data into video data corresponding to the received viewport information, and render a video corresponding to the received viewport information. Therefore, the viewport sharing server may enable the user to share viewports of other users or the administrator, and the increased amount of information may be presented to the user. In addition, the amount of information exchanged between a user and other users or the administrator may also considerably increase.

### BRIEF DESCRIPTION OF THE DRAWINGS

The above and/or other aspects will become more apparent and more readily appreciated from the following detailed description to non-limiting embodiments with reference to the accompanying drawings, wherein:

FIG. 1 is a diagram illustrating an exemplary system architecture to which the present disclosure can be applied;

FIG. 2 is diagram illustrating an exemplary architecture of the interior of a system for sharing a VR viewport according to an exemplary embodiment;

FIG. 3 is diagram illustrating an exemplary interface rendered by a viewport sharing server;

FIG. 4 is an exemplary signaling diagram illustrating that terminal A sharing viewport information with terminal B or a viewport sharing server;

FIG. 5 is an exemplary signaling diagram illustrating that terminal A tracking viewport information of terminal B or a viewport sharing server;

FIG. 6 is an exemplary signaling diagram illustrating a viewport sharing server pushing viewport information thereof to terminal A and terminal B; and

FIG. 7 is a schematic structural diagram of a computer system adapted to implement a terminal device or a server according to an exemplary embodiment.

### DETAILED DESCRIPTION OF EXEMPLARY EMBODIMENTS

The present disclosure will be further described below in detail in combination with the accompanying drawings and exemplary embodiments. It should be appreciated that the specific embodiments described herein are merely used for illustration, rather than limiting the present disclosure. In addition, it should be noted that, for the ease of description, only the parts related to the exemplary embodiments are shown in the accompanying drawings.

Various changes may be made to an embodiment of the present disclosure, and the present disclosure may come with a diversity of embodiments. Some embodiments of the present disclosure are shown and described in connection with the accompanying drawings. However, it should be appreciated that the present disclosure is not limited to the embodiments, and all changes and/or equivalents or replacements are intended to be included in the scope of the present disclosure as defined by the appended claims.

Certain terms or phrases used herein may be defined merely for ease of description. As used herein, the terms “include” and “comprise” and their derivatives may indicate doing so without any limitations. As used herein, the term “or” may be used interchangeably with the term “and/or.” As used herein, the phrases “associated with,” “associated therewith” and their derivatives may be used interchangeably with the terms “include,” “be included within,” “interconnect with,” “contain,” “be contained within,” “connect to or with,” “couple to or with,” “be communicable with,” “cooperate with,” “interleave,” “juxtapose,” “be proximate to, “be bound to or with, “have, and “have a property of.” As used herein, the term “controller” may indicate any device, system, or part thereof controlling at least one operation. As used herein, the term “device” may indicate a device that may be implemented in hardware, firmware, software, and some combination of at least two thereof. It should be noted that functions, whatever certain controller is associated therewith, may be concentrated, distributed, and implemented locally or remotely. It should be appreciated by one of ordinary skill in the art that the definitions of certain terms or phrases as used herein may be adopted for the present or the future in many cases.

As used herein, the singular forms “a,” “an,” and “the” are intended to include the plural forms as well, unless the context clearly indicates otherwise. Accordingly, as an example, a “component surface” includes one or more component surfaces.

The terms coming with ordinal numbers such as “first” and “second” may be used to denote various components, but the components are not intended to be limited by the terms. The terms are used only to distinguish one component from another. For example, a first component may be referred to as a second component, and vice versa without departing from the scope of the present disclosure. The term “and/or” may refer to a combination(s) of a plurality of related items as listed or any of the items.

The terms as used herein are provided merely to describe embodiments of the present disclosure, but are not intended to limit the present disclosure. It will be further understood that the terms “comprise” and/or “have,” when used in the present disclosure, indicate the presence of stated features, integers, steps, operations, elements, and/or components, but do not preclude the presence or addition of one or more other features, integers, steps, operations, elements, components, and/or groups thereof.

Unless otherwise defined in connection with an embodiment of the present disclosure, all terms used herein have the same meaning as commonly understood by one of ordinary skill in the art to which an embodiment of the present disclosure belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

According to an embodiment of the present disclosure, an electronic device as disclosed herein may include a communication function. For example, the electronic device may be a smartphone, a tablet personal computer (PC), a PC, a mobile phone, a video phone, an electronic book (e-book) reader, a desktop PC, a laptop PC, a netbook PC, a personal digital assistant (PDA), a portable multimedia player (PMP), a moving picture experts group audio layer 3 (MP3) player, a mobile medical device, a camera, a wearable device (e.g., an HMD), electronic clothes, an electronic bracelet, an electronic necklace, an electronic appcessory, an electronic tattoo, or a smart watch.

According to an embodiment of the present disclosure, an electronic device may be a smart home appliance with a communication function. For example, the smart home appliance may be a television, a digital video disk (DVD) player, an audio player, a refrigerator, an air conditioner, a vacuum cleaner, an oven, a microwave oven, a washer, a drier, an air cleaner, a set-top box, a TV box (e.g., Samsung HomeSync®, Apple TV®, or Google TV™), a gaming console, an electronic dictionary, a camcorder, or an electronic picture frame.

According to an embodiment of the present disclosure, an electronic device may be a medical device (e.g., a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, an electronic device for sailing (e.g., a navigation device, a gyroscope, or a compass), an aviation electronic device, a security device, or a robot for home or industry.

According to an embodiment of the present disclosure, an electronic device may be a piece of furniture with a communication function, part of a building/structure, an electronic board, an electronic signature receiving device, a projector, or various measurement devices (e.g., devices for measuring water, electricity, gas, or electromagnetic waves).

According to an embodiment of the present disclosure, an electronic device may be a combination of the above-listed devices. It should be appreciated by one of ordinary skill in the art that an electronic device is not limited to the above-described devices.

According to an embodiment of the present disclosure, a device for transmitting and receiving VR content may be, e.g., an electronic device.

The terms as used herein are defined as follows. An image may be a video or a still image. Image content may include various multimedia content including audio or a subtitle, but not a video or a still image by itself. VR content includes image content that provides an image as a 360-degree image or a 3D image. Media file format may be a media file format that follows various media-related standards, such as an International Standards Organization (ISO)-based media file format (ISOBMFF). Projection indicates a process for projecting a spherical image for representing, e.g., a 360-degree image onto a planar surface or an image frame obtained as per a result of the process. Mapping indicates a process for mapping image data on a planar surface by projection to a two-dimensional (2D) planar surface or an image frame obtained as per a result of the process. Omnidirectional media includes an image or video that may be rendered as per a user's viewport or a direction in which the user's head moves, e.g., when the user uses an HMD and/or its related audio. A viewport may be referred to as a field of view (FOY), indicating a region of an image viewed by a user at a certain view point (here, the region of the image may be the region of a spherical image). Additionally, viewport may be defined by using a FOV and a viewpoint. Herein, FOV may be defined as including both a horizontal view angle and a vertical view angle, and a viewport may be an FOV area of an image corresponding to a certain viewpoint.

A method for sharing a viewport in a viewport server using viewport sharing system including content distribution server, viewport sharing server, and a plurality of terminals, the method comprising: receiving panoramic video data multicast from the content distribution server; receiving, from a first terminal, first viewport information generated by the first terminal; transmitting, to a second terminal, the first viewport information; transmitting, to a third terminal, a second viewport information generated by the viewport sharing server; generating first video data, by rendering the panoramic video data based on the first viewport information; and generating second video data, by rendering the panoramic video data based on the second viewport information, wherein the first terminal, the second terminal and the third terminal, are configured to be included in the plurality of terminals.

The method further comprises: establishing a first transmission connection with the content distribution server; and establishing a second transmission connection with one of the plurality of terminals; wherein the receiving panoramic video data comprises receiving the panoramic video data through the first transmission connection, and wherein the transmitting or the receiving the first viewport information comprises transmitting or receiving the first viewport information through the second transmission connection, and wherein the receiving the second viewport information comprises receiving the second viewport information through the second transmission connection.

Additionally, the first viewport information includes pitch angle information, yaw angle information, view owner information, and sharing flag, and the second viewport information includes pitch angle information, yaw angle information, view owner information, and sharing flag.

The method further comprises: receiving, from the third terminal, a first request to track the viewport of the viewport sharing server, and transmitting, to the third terminal, the second viewport information in response to the first request; and receiving, from the second terminal, a second request to track the viewport of the first terminal, and transmitting, to the second terminal, the first viewport information in response to the second request.

The method may further comprise: transmitting the first video data to one of: the second terminal and the third terminal; and transmitting the second video data, to one of: the first terminal, the second terminal and the third terminal.

A method for sharing a viewport in a terminal using viewport sharing system including content distribution server, viewport sharing server, and a plurality of terminals, the method may comprise: receiving panoramic video data multicast from the content distribution server; generating first viewport information; transmitting, to the viewport sharing server, the first viewport information; receiving, from the viewport sharing server, second viewport information; generating first video data, by rendering the panoramic video data based on the first viewport information; and generating second video data, by rendering the panoramic video data based on the second viewport information.

The method may further comprise: establishing a first transmission connection with the content distribution server; and establishing a second transmission connection with the viewport sharing server; wherein the receiving panoramic video data comprises receiving the panoramic video data through the first transmission connection, and wherein the transmitting the first viewport information comprises transmitting the first viewport information through the second transmission connection, and wherein the receiving the second viewport information comprises receiving the second viewport information through the second transmission connection.

The first viewport information may include pitch angle information, yaw angle information, view owner information, and sharing flag, and the second viewport information may include pitch angle information, yaw angle information, view owner information, and sharing flag.

The method further comprises: transmitting, to the viewport sharing server, a first request to track the viewport of the viewport sharing server, and receiving, from the viewport sharing server, the viewport information of the viewport sharing server corresponding to the first request; and transmitting, to the viewport sharing server, a second request to track the viewport of another terminal, and receiving, from the viewport sharing server, the viewport information of the another terminal corresponding to the second request.

The method further comprises: transmitting the first video data to the viewport sharing server; and transmitting the second video data, to the viewport sharing server.

A apparatus for sharing a viewport, the apparatus comprises: a first transceiver configured to receive panoramic video data multicast from a content distribution server; a second transceiver configured to: receive, from a first terminal, first viewport information generated by the first terminal, transmit, to a second terminal, the first viewport information, and transmit, to a third terminal, a second viewport information generated by the viewport sharing server; and a controller including at least one processor and a memory; wherein the controller is configured to: generate first video data, by rendering the panoramic video data based on the first viewport information, and generate second video data, by rendering the panoramic video data based on the second viewport information, wherein the first terminal, the second terminal and the third terminal, are configured to be included in the plurality of terminals.

A apparatus for sharing a viewport, the apparatus comprises: a first transceiver configured to receive panoramic video data multicast from a content distribution server; a second transceiver configured to transmit, to the viewport sharing server, the first viewport information, and receive, from a viewport sharing server, second viewport information; a controller including at least one processor and a memory; wherein the controller is configured to: generate first viewport information; generate first video data, by rendering the panoramic video data based on the first viewport information; and generate second video data, by rendering the panoramic video data based on the second viewport information.

It should also be noted that the exemplary embodiments in the present disclosure and the features in the embodiments may be combined with each other on a non-conflict basis. The present disclosure will be described below in detail with reference to the accompanying drawings and in combination with the exemplary embodiments.

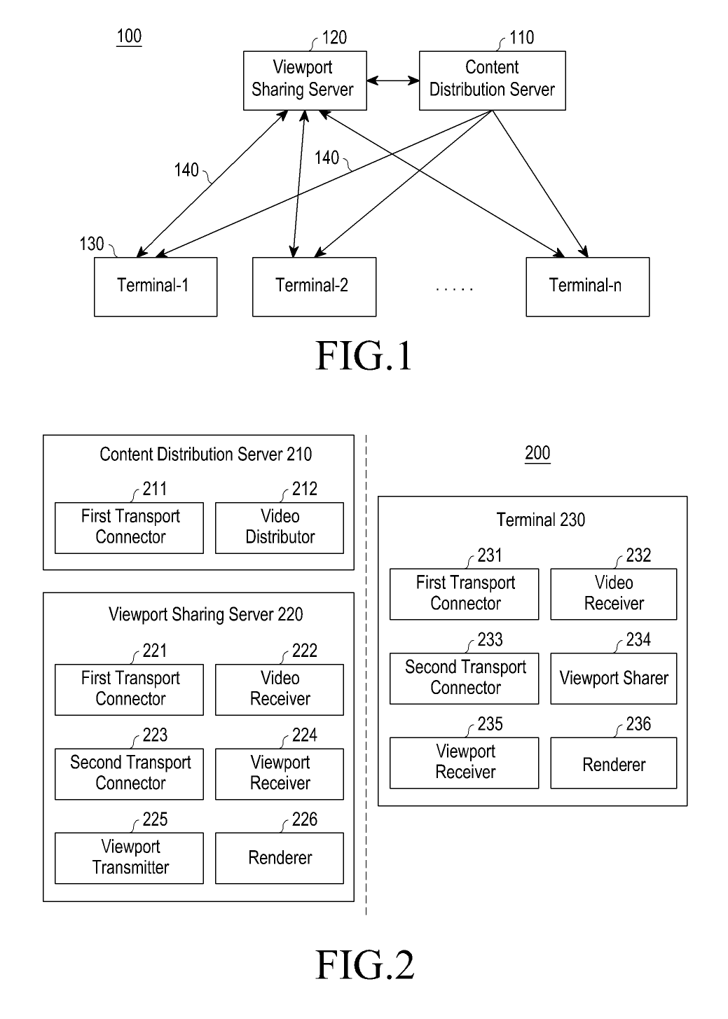

As shown in FIG. 1, the system architecture 100 may include a content distribution server 110, a viewport sharing server 120, n terminals 130 (where n is an integer greater than 0), and a network 140. The content distribution server 110 may be a content delivery server. The network 140 is a medium for providing a communication link among the content distribution server 110, the viewport sharing server 120, and the n terminals 130. The network 140 may include various connection types, such as wired and wireless communication links or optical fiber cables. For examples, the network 140 may be a local area network (LAN) or a wide area network (WAN) such as the Internet.

A user may use the terminal 130 to interact with the content distribution server 110 and the viewport sharing server 120, respectively, through the network 140 to receive or transmit a message or the like. Various client applications, such as a VR application, an instant messenger, an email client, or social networking platform software, may be installed on the terminal 130.

The terminal 130 may be various electronic devices having a display screen and supporting the VR technology, including, but not limited to, a VR head-mounted display (HMD) device based on a mobile terminal or a computer, VR smart glasses based on a mobile terminal or a computer, etc.

It should be noted that the method for sharing a VR viewport is generally executed by the content distribution server 110, the viewport sharing server 120, and the terminal 130. Accordingly, the system for sharing a VR viewport generally includes a content distribution server 110, a viewport sharing server 120, and a terminal 130.

It should be appreciated that that the numbers of the content distribution servers 110, the viewport sharing servers 120, the terminals 130, and the networks 140 suggested in FIG. 1 are merely exemplary. Any number of terminal devices, networks, and servers may be feasible according to actual demands. For example, according to an aspect of an exemplary embodiment, the system for sharing a VR viewport may include at least one content distribution server 110, at least one viewport sharing server 120 and at least one terminal 130.

In the above-mentioned system 100 for sharing a VR viewport, the content distribution server 110 is configured to establish first transport connections to a terminal and a viewport sharing server, respectively, to multicast panoramic video data. That is, the panoramic video data is transmitted over the Real-time Transport Protocol (RTP), in which an RTP packet includes timestamps and code data of the panoramic video, and one panoramic video data frame may consist of one or more RTP packets.

Herein, the first transport connection may be a connection method suitable for multicasting or broadcasting panoramic video data that is well-known in the prior art or to be developed in the future, which is not limited in the present disclosure. As an example, the first transport connection may be an RTP connection.

In the above-mentioned system 100 for sharing a VR viewport, the viewport sharing server 120 is configured to establish a first transport connection to the content distribution server to receive the panoramic video data, establish a second transport connection to the terminal to receive viewport information sent by the terminal or transmit viewport information to the terminal, and render the received viewport information. Herein, the viewport information transmitted through the second transport connection may include user viewport information and viewport owner information (e.g., user information). For example, the viewport information may include a pitch angle of the viewport, a yaw angle of the viewport, and viewport owner information. The viewport information may further include sharing flag information that indicates the sharing status of the viewport with other terminals.

Herein, the second transport connection may be a connection method suitable for transmitting viewport information that is well-known in the prior art or to be developed in the future, which is not limited in the present disclosure. As an example, the second transport connection may be a Transmission Control Protocol (TCP) session or a User Datagram Protocol (UDP) connection.

In the above-mentioned system 100 for sharing a VR viewport, the terminal 130 is configured to establish a first transport connection to the content distribution server to receive the panoramic video data, convert the panoramic video data into video data within a user viewport scope, render a video within the user viewport scope, establish a second transport connection to the viewport sharing server to supply the viewport information of the terminal, receive the viewport information transmitted from the viewport sharing server, convert the panoramic video data into video data corresponding to the received viewport information, and render a video corresponding to the received viewport information. The user viewport scope may refer to the viewport that is currently being selected by the user for the terminal. For example, the user viewport scope may be the viewport through which the user may be currently viewing an image on a head-mounted display. Thus, converting the panoramic video data into the video data or rendering the video within a user viewport scope implies that the video data may be confined (e.g., cropped) to the user viewport scope or the current viewport of the user.

In some scenarios, the user may expect to share the viewport of the local terminal with other terminals. In this case, the terminal 130 is further configured to supply viewport information, indicating that sharing flag information in the viewport information has been set to a predetermined value (e.g., sharing is enabled), to the viewport sharing server if a user has set the sharing flag information to the predetermined value to enable sharing. In addition, the viewport sharing server 120 may be further configured to transmit viewport information indicating that the sharing flag information has been set to the predetermined value to a terminal in a network thereby allowing the other terminal to receive the viewport information transmitted from the viewport sharing server in response to reception of the viewport information from the original terminal.

In some scenarios, the user may wish to track the viewport provided by the viewport sharing server. For example, a coach may wish to track or monitor the viewports of all the terminals associated with the members of a sports team. In this case, the terminal 130 may be further configured to transmit, if a viewport sharing mode set by a user is a viewport tracking mode for the viewport sharing server 120, a first request for acquiring the viewport information received by the viewport sharing server 120 to the viewport sharing server 120 and receive only viewport information transmitted from the viewport sharing server 120 (and no other viewport information) in response to the first request. In addition, the viewport sharing server 120 may be further configured to transmit, in response to reception of the first request, only the viewport information received by the viewport sharing server to the terminal.

In some other scenarios, the user may wish to track the viewport of another user. In this case, the terminal 130 may be further configured to transmit, if a viewport sharing mode set by a user is a viewport tracking mode for a predetermined terminal, a second request for acquiring viewport information of the predetermined terminal to the viewport sharing server 120 and receive the viewport information of the predetermined terminal transmitted from the viewport sharing server 120 in response to the second request. In addition, the viewport sharing server 120 may be further configured to transmit, in response to reception of the second request, the viewport information of the predetermined terminal (e.g., Terminal-2) to the terminal (e.g., Terminal-1).

In some other scenarios, the user may expect not to be disturbed by other users or the viewport sharing server 120. In this case, the terminal 130 may be further configured to stop (e.g., reject, terminate, or opt out of), if a viewport sharing mode set by a user is a do not disturb (DND) mode, receiving the viewport information transmitted from the viewport sharing server 120. Here, it should be noted that the method for opting out of receiving the viewport information transmitted from the viewport sharing server 120 may be a method for stopping receiving information that is well known in the prior art or to be developed in the future, which is not limited in the present disclosure. For example, the terminal 130 may reject any message transmitted from the viewport sharing server 120, or may disconnect from the viewport sharing server 120 to stop receiving the viewport information transmitted from the viewport sharing server 120. As an alternative, the terminal 130 may transmit a request for setting a DND mode to the viewport sharing server 120. In such a case, when the terminal needs to return to the default mode (e.g., sharing mode) for the viewport sharing server 120, the terminal 130 may transmit a request for returning to the default mode to the viewport sharing server 120.

In some scenarios, in case that the terminal 130 renders the video within the user viewport scope and the video corresponding to the received viewport information to the user, the terminal 130 may render, if a rendering mode set by a user is a picture-in-picture (PIP) mode, the video corresponding to the received viewport information in the rendered video within the user viewport scope, or render the video within the user viewport scope in the rendered video corresponding to the received viewport information (e.g., render one of the videos in an inset window inside of another video). As an alternative, if a rendering mode set by a user is a full screen mode, the terminal 130 may render the video corresponding to the received viewport information in full screen.

In some scenarios, the administrator of the viewport sharing server 120 may transmit, by means of the viewport sharing server 120, viewport information of the viewport sharing server 120 to all of the terminals 130 and allow them to receive the shared viewport (e.g., when the administrator is a coach), so as to enable the terminals 130 to monitor situations related to other terminals. That is, the viewport sharing server 120 may be further configured to transmit, in response to reception of a sharing operation, the viewport information received by the viewport sharing server 120 to a terminal in a network and allow the terminal to receive the viewport information transmitted from the viewport sharing server 120.

In some scenarios, the viewport sharing server 120 may display the received viewport information, and be further configured to: directly render a video corresponding to the received viewport information based on the panoramic video data and the received viewport information; or render, in response to reception of a selection operation to the received viewport information rendered by the viewport sharing server, the video corresponding to the received viewport information based on the panoramic video data and the received viewport information.

The system for sharing a VR viewport provided in the above-mentioned exemplary embodiment of the present disclosure makes it possible to share video contents between different terminals and between the viewport sharing server and the terminals through the second transport connections between the terminals and the viewport sharing server. Therefore, the volume of information presented to the user is largely increased, and the user experience is improved accordingly.

FIG. 2 illustrates an exemplary architectural diagram of the interiors of a content distribution server, a viewport sharing server, and terminals in a system for sharing a VR viewport according to an exemplary embodiment.

As shown in FIG. 2, the system for sharing a VR viewport may include a content distribution server 210, a viewport sharing server 220, and a terminal 230. The content distribution server 210, the viewport sharing server 220, and the terminal 230 may respectively correspond to the content distribution server 110, the viewport sharing server 120, and the terminal 130 of FIG. 1. The various units, modules, components, etc. illustrated in FIG. 2 and other figures may be implemented with hardware (e.g., circuit, microchip, etc.), software (e.g., program instructions), or a combination of both.

The content distribution server 210 may include an apparatus that includes a first transport connector 211 and a video distributor 212.

In this exemplary embodiment, the first transport connector 211 may be configured to establish a connection to a first transport connector 221 of the viewport sharing server 220 and a first transport connector 231 of the terminal 230, respectively. The video distributor 212 may be configured to multicast panoramic video data to the terminal 230 and the viewport sharing server 220, respectively, through the established first transport connections.

Herein, the first transport connection may be a connection method suitable for multicasting panoramic video data that is well known in the prior art or to be developed in the future, which is not limited in the present disclosure. As an example, the first transport connection may be a RTP connection.

The viewport sharing server 220 may include a first transport connector 221, a video receiver 222, a second transport connector 223, a viewport receiver 224, a viewport transmitter 225, and a renderer 226.

The first transport connector 221 may be configured to establish a first transport connection to a content distribution server 210. The video receiver 222 may be configured to receive, through the first transport connection, panoramic video data multicast by the content distribution server 210. The second transport connector 223 may be configured to establish a second transport connection to the terminal 230. The viewport receiver 224 may be configured to receive, through the second transport connection, viewport information supplied by the terminal 230. The viewport transmitter 225 may be configured to transmit viewport information to the terminal 230 through the second transport connection. The renderer 226 may be configured to render the received viewport information.

Herein, the first transport connection may be a connection method suitable for multicasting panoramic video data that is well known in the prior art or to be developed in the future, which is not limited in the present disclosure. As an example, the first transport connection may be a RTP connection. Herein, the second transport connection may be a connection method suitable for transmitting viewport information that is well known in the prior art or to be developed in the future, which is not limited in the present disclosure. As an example, the second transport connection may be a TCP session or a UDP connection. Optionally, according to a sharing instruction transmitted from a user terminal, the viewport sharing server 220 may transmit, by means of the viewport transmitter 225, viewport information thereof to a terminal and allow the terminal to receive the viewport information transmitted from the viewport sharing server 220. That is, the viewport transmitter 225 may be further configured to transmit, in response to reception of viewport information indicating that the sharing flag information has been set to the predetermined value (e.g., sharing is enabled) from the terminal, the viewport information to a terminal in a network and allow the terminal to receive the viewport information transmitted from the viewport sharing server.

Optionally, the viewport sharing server 220 may respond to a tracking request from a user by means of the viewport transmitter 225. That is, the viewport transmitter 225 may be further configured to transmit, in response to reception of a first request transmitted from the terminal 230, only the viewport information received by the viewport sharing server 220 (and no other viewport information) to the terminal 230, wherein the first request is a request for acquiring the viewport information received by the viewport sharing server 220 and is transmitted from the terminal 230 to the viewport sharing server 220 if a viewport sharing mode set by a user is a viewport tracking mode for the viewport sharing server 220. Alternatively, the viewport transmitter 225 may be further configured to transmit, in response to reception of a second request transmitted from the terminal 230, viewport information of a predetermined terminal to the terminal through the second transport connection, wherein the second request is a request for acquiring the viewport information of the predetermined terminal and is transmitted from the terminal to the viewport sharing server if a viewport sharing mode set by a user is a viewport tracking mode for the predetermined terminal.

Optionally, according to a sharing operation input by the administrator of the viewport sharing server 220, the viewport sharing server 220 may transmit, by means of the viewport transmitter 225, the viewport information received by the viewport sharing server 220 to a terminal 230 and allow the terminal 230 to receive the viewport information transmitted from the viewport sharing server 220. That is, the viewport transmitter 225 may be further configured to transmit, in response to reception of a sharing operation, the viewport information received by the viewport sharing server 220 to a terminal 230 in a network and allow the terminal 230 to receive the viewport information transmitted from the viewport sharing server 220.

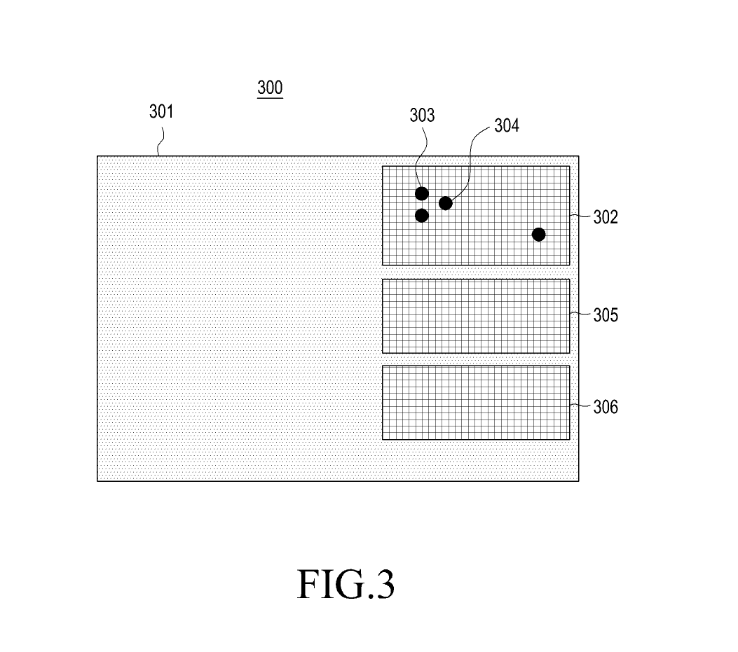

Optionally, the viewport sharing server may render, by means of the renderer 226, the video corresponding to the received viewport information. That is, the renderer 226 may be configured to render a video corresponding to the received viewport information based on the panoramic video data and the received viewport information. As an alternative, the renderer 226 may be configured to render, in response to reception of a selection operation to the received viewport information rendered by the viewport sharing server 220, the video corresponding to the received viewport information based on the panoramic video data and the received viewport information. As an example, reference is made to FIG. 3, which illustrates a video content display area 301 of the viewport sharing server 220, where 302 is a terminal viewport display area, and 303 and 304 correspond to different terminal viewports, respectively. When the administrator clicks the terminal viewports 303 and 304, video contents corresponding to the terminal viewports may be displayed, as shown by 305 and 306.

Referring back to FIG. 2, the terminal 230 may include a first transport connector 231, a video receiver 232, a second transport connector 233, a viewport sharer 234, a viewport receiver 235, and a renderer 236.

In this exemplary embodiment, the first transport connector 231 is configured to establish a first transport connection to a content distribution server 210. The video receiver 232 is configured to receive panoramic video data through the first transport connection. The second transport connector 233 is configured to establish a second transport connection to a viewport sharing server 220. The viewport sharer 234 is configured to supply viewport information of the terminal 230 through the second transport connection. The viewport receiver 235 is configured to receive viewport information transmitted from the viewport sharing server 220. The renderer 236 is configured to convert the panoramic video data into video data within a user viewport scope, and render a video within the user viewport scope; or configured to convert the panoramic video data into video data corresponding to the received viewport information, and render a video corresponding to the received viewport information.

Herein, the first transport connection may be a connection method suitable for multicasting panoramic video data that is well known in the prior art or to be developed in the future, which is not limited in the present disclosure. As an example, the first transport connection may be a RTP connection. Herein, the second transport connection may be a connection method suitable for transmitting viewport information that is well known in the prior art or to be developed in the future, which is not limited in the present disclosure. As an example, the second transport connection may be a TCP session or a UDP connection.

Optionally, the user may request, by means of the viewport sharer 234, for the viewport sharing server 220 to share the viewport of the local terminal with other terminals. That is, the viewport sharer may be further configured to supply, if a user has set sharing flag information in the viewport information to a predetermined value, viewport information indicating that the sharing flag information has been set to the predetermined value to the viewport sharing server 220 through the second transport connection.

Optionally, the user may transmit a viewport tracking request to the viewport sharing server 220 by means of the viewport tracker disposed in the terminal, and receive viewport information supplied by the viewport sharing server 220. In this case, the terminal 230 may further include: a viewport tracker configured to transmit, if a viewport sharing mode set by a user is a viewport tracking mode for the viewport sharing server 220, a first request for acquiring the viewport information received by the viewport sharing server 220 to the viewport sharing server 220; or configured to transmit, if a viewport sharing mode set by a user is a viewport tracking mode for a predetermined terminal, a second request for acquiring viewport information of the predetermined terminal to the viewport sharing server 220. In this case, the viewport receiver 235 may be further configured to receive viewport information transmitted from the viewport sharing server 220 in response to the first request; or receive the viewport information of the predetermined terminal transmitted from the viewport sharing server 220 in response to the second request.

Optionally, the user may wish to stop rendering the viewport information transmitted from the viewport sharing server 220. In this case, the renderer 236 may be further configured to stop, if a viewport sharing mode set by a user is a DND mode, rendering the viewport information transmitted from the viewport sharing server 220.

Optionally, when rendering to the user the video within the user viewport scope and the video corresponding to the received viewport information, the renderer 236 may render, if a rendering mode set by a user is a PIP mode, the video corresponding to the received viewport information in the rendered video within the user viewport scope, or render the video within the user viewport scope in the rendered video corresponding to the received viewport information. As an alternative, the renderer 236 may render, if a rendering mode set by a user is a full screen mode, the video corresponding to the received viewport information in full screen.

It should be appreciated by those skilled in the art that the structures of the content distribution server 210, the viewport sharing server 220, and the terminal 230 shown in FIG. 2 are merely exemplary and are not considered as a limitation to the present disclosure, and the modules in FIG. 2 may be substituted with any modules capable of implementing the functions corresponding to the modules or variations of the modules. For example, the functions of the first transport connector 221 and the second transport connector 223 of the viewport sharing server 220 in FIG. 2 may be integrated into a session manager, and the session manager may be used for establishing the first transport connection to the content distribution server 210 and the second transport connection to the terminal 230. In this case, the session manager may be a module obtained by combining the first transport connector 221 and the second transport connector 223. In addition, the above-mentioned apparatus for sharing a VR viewport may further include other well-known structures, for example, a processor and a memory. These well-known structures are not shown to avoid unnecessarily obscuring the exemplary embodiments of the disclosure.

The system for sharing a VR viewport provided in the above-mentioned exemplary embodiment of the present disclosure may include a content distribution server 210, a viewport sharing server 220, and a terminal 230. As a consequence, the sharing of video contents among different terminals and between the viewport sharing server and the terminals can be achieved, an increased amount of information may be presented to the user, and the user experience may be improved significantly.

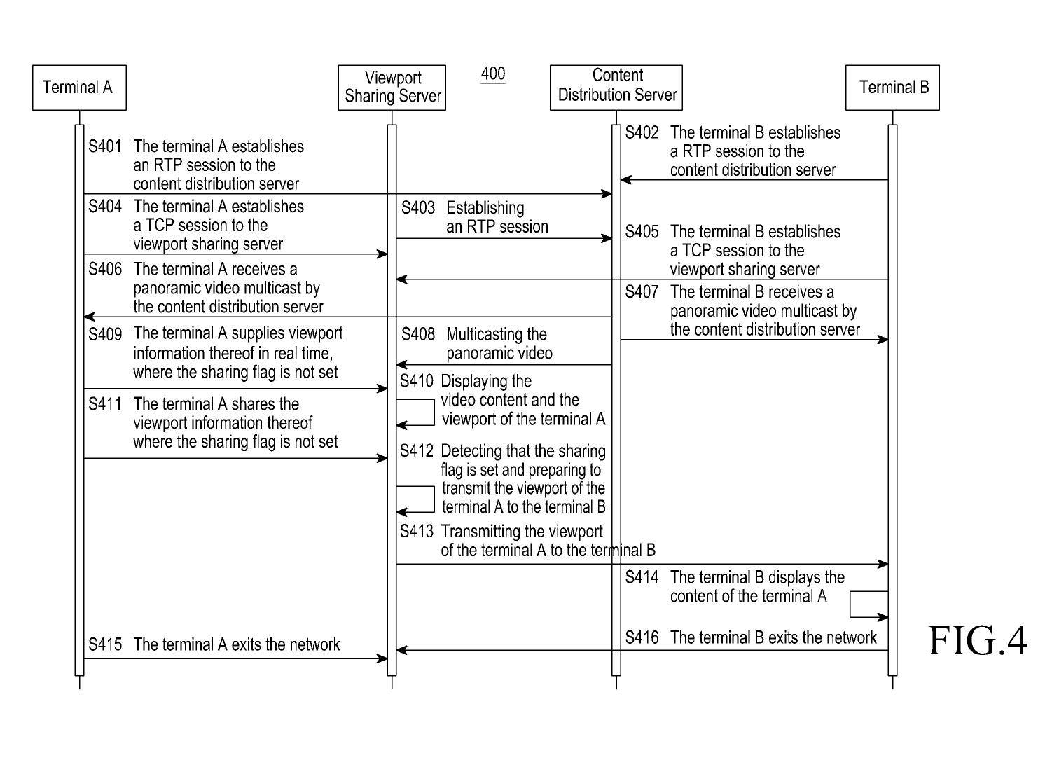

A procedure in which terminal A shares viewport information with terminal B or a viewport sharing server is described below with reference to FIG. 4.

FIG. 4 is an exemplary signaling diagram illustrating terminal A sharing viewport information with terminal B or a viewport sharing server. As shown in FIG. 4, the signaling diagram 400 includes the following steps.

At steps S401 through S403, terminal A, terminal B, and a viewport sharing server may respectively establish RTP sessions with a content distribution server, where the request message includes IP address and port information of the content distribution server.

At steps S404 through S405, the terminal A and the terminal B may respectively establish TCP sessions with the viewport sharing server, where the request message includes IP address and port information of the viewport sharing server.

At steps S406 through S408, the content distribution server may transmit panoramic video data to terminal A, terminal B and the viewport sharing server, respectively, by means of RTP multicast, where the RTP packet includes timestamps and code data of the panoramic video. One panoramic video data frame may consist of one or more RTP packets.

At step S409, the terminal A may supply viewport information thereof in real time, where the viewport information includes a pitch angle of the viewport, a yaw angle of the viewport, viewport owner information, and/or sharing flag information. The sharing flag may remain default and not be set at this time.

At step S410, the viewport sharing server may receive the viewport of terminal A, detect that the sharing flag is not set, display the viewport of terminal A by means of the renderer, and display a video within a viewport scope of terminal A after the viewport of terminal A is selected.

At step S411, terminal A may share the viewport thereof by using a share button, where the viewport information is the same as that in step S409, and the sharing flag may be set. In this case, terminal A may transmit the viewport information to the viewport sharing server.

At step S412, the viewport sharing server may detect that the sharing flag of terminal A is set, and prepare to transmit the viewport of the terminal A to the terminal B.

At step S413, the viewport of terminal A may be transmitted to the terminal B in TCP. Steps S409 through S413 are illustrative. If terminal A does not share its viewport with other terminals, terminal A may operate according to the steps S409 and S410. If terminal A shares its viewport with other terminals, it can operate according to steps S411 through S413.

At step S414, if terminal B is set to a free mode, the video content of terminal A may be displayed in a PIP mode on the basis of the original video. Alternatively, terminal B may display the video content of terminal A in a full screen mode.

At steps S415 through S416, terminal A and terminal B may disable their respective ports, and terminate the established session.

It should be appreciated by those skilled in the art that the above-mentioned steps shown in FIG. 4 are merely an exemplary embodiment where terminal A shares the viewport information with terminal B or the viewport sharing server, and are not considered as a limitation to the present disclosure. For example, as for FIG. 4, steps S401 and S402 may be performed in reverse order, and steps S406, S407, and S408 may be performed concurrently. One or more steps illustrated in FIG. 4 and other figures may be omitted or performed in a different order. One or more additional steps may be added as well.

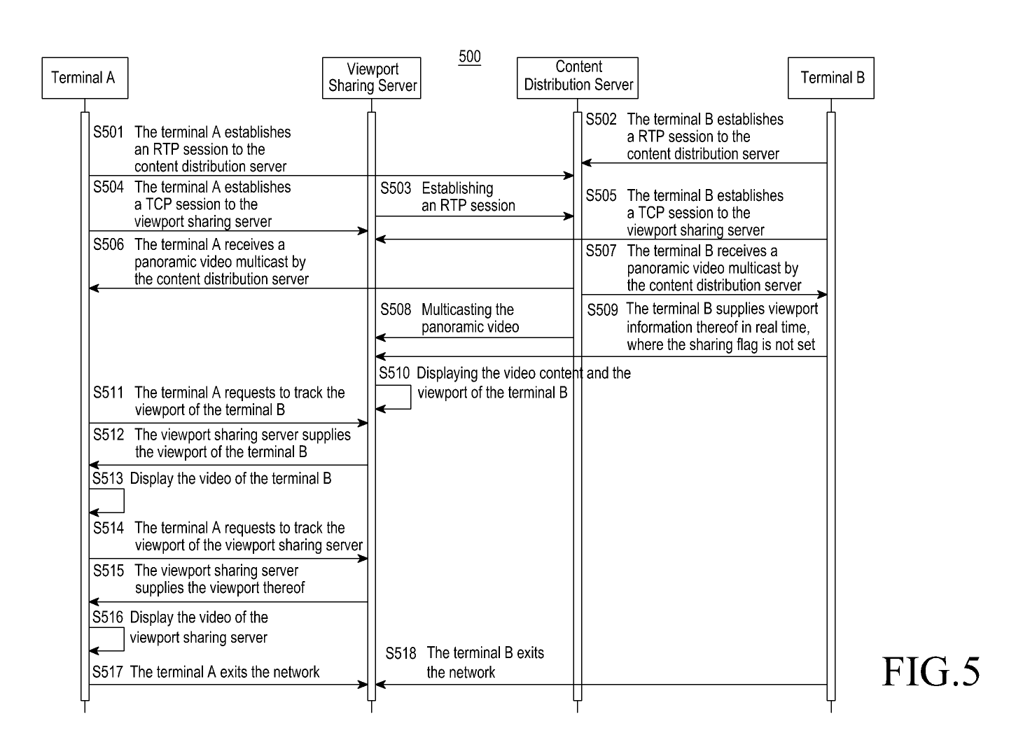

A procedure in which terminal A tracks viewport information of terminal B or a viewport sharing server is described below with reference to FIG. 5.

FIG. 5 is an exemplary signaling diagram illustrating terminal A tracking viewport information of terminal B or a viewport sharing server. As shown in FIG. 5, the signaling diagram 500 includes the following steps.

At steps S501 through S503, terminal A, terminal B, and a viewport sharing server may respectively establish RTP sessions with a content distribution server, where the request message includes IP address and port information of the content distribution server.

At steps S504 through S505, terminal A and terminal B may respectively establish TCP sessions with the viewport sharing server, where the request message includes IP address and port information of the viewport sharing server.

At steps S506 through S508, the content distribution server may transmit panoramic video data to terminal A, terminal B and the viewport sharing server, respectively, by means of RTP multicast, where the RTP packet includes timestamps and code data of the panoramic video. One panoramic video data frame may consist of one or more RTP packets.

At step S509, terminal B may supply viewport information thereof in real time, where the viewport information includes a pitch angle of the viewport, a yaw angle of the viewport, viewport owner information, and/or sharing flag information. The sharing flag may remain default and not be set at this time.

At step S510, the viewport sharing server may receive the viewport of terminal B, detect that the sharing flag is not set, display the viewport of terminal B by means of the renderer, and display a video within a viewport scope of terminal B after the viewport of terminal B is selected.

At step S511, terminal A may submit a viewport tracking request to the viewport sharing server to browse the virtual content from the same viewport as that of terminal B.

At step S512, the viewport sharing server may receive the request from terminal A and supply the viewport information of terminal B.

At step S513, terminal A may acquire the viewport information of terminal B, and display the virtual content within the viewport scope of terminal B in a full screen mode.

At step S514, terminal A may submit a viewport tracking request to the viewport sharing server to browse the virtual content from the same viewport as that of the viewport sharing server.

At step S515, the viewport sharing server may receive the request from terminal A and supply viewport information of the viewport sharing server.

At step S516, terminal A may acquire the viewport information of the viewport sharing server, and display the virtual content within the viewport scope of the viewport sharing server in a full screen mode.

At steps S517 through S518, terminal A and terminal B may disable their ports, respectively, and terminate the established session.

It should be appreciated by those skilled in the art that the above-mentioned steps shown in FIG. 5 are merely an exemplary embodiment where terminal A tracks viewport information of terminal B or the viewport sharing server, and are not considered as a limitation to the present disclosure. For example, as for FIG. 5, steps S501 and S502 may be performed in reverse order, and steps S505, S506, and S507 may be performed concurrently.

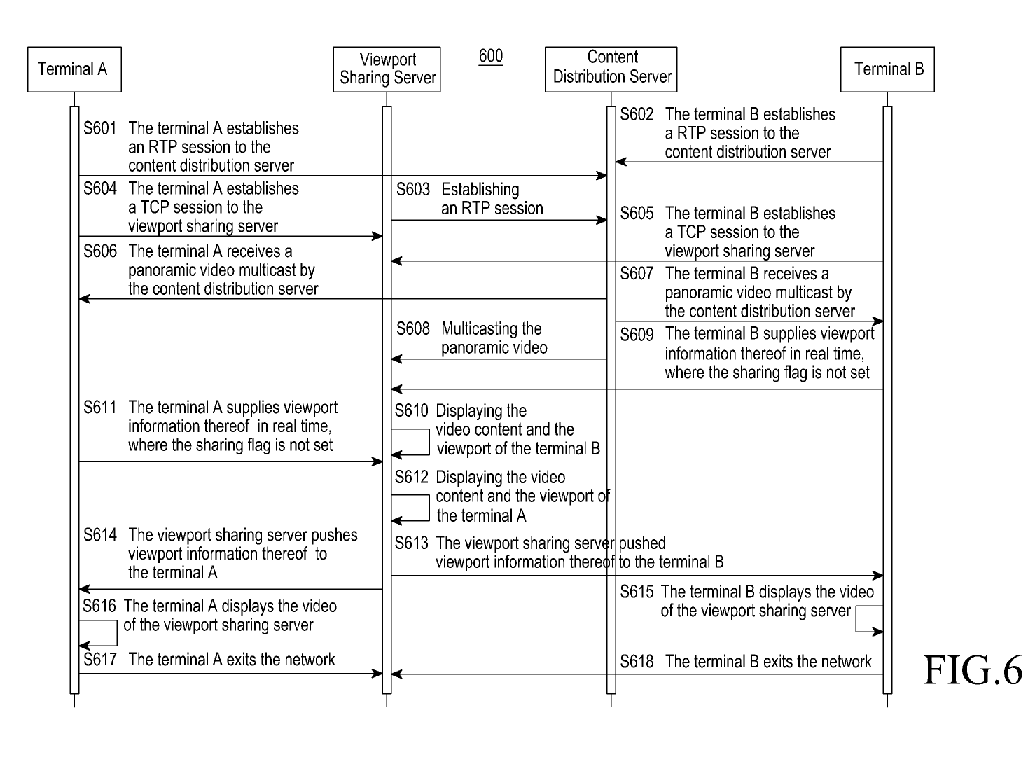

A procedure in which a viewport sharing server pushes viewport information thereof to terminal A and terminal B is described below with reference to FIG. 6.

FIG. 6 is an exemplary signaling diagram illustrating a viewport sharing server pushing viewport information thereof to terminal A and terminal B. As shown in FIG. 6, the signaling diagram 600 may include the following steps.

At steps S601 through S603, terminal A, terminal B, and a viewport sharing server may respectively establish RTP sessions with a content distribution server, where the request message includes IP address and port information of the content distribution server.

At steps S604 through S605, terminal A and terminal B may respectively establish TCP sessions with the viewport sharing server, where the request message includes IP address and port information of the viewport sharing server.

At steps S606 to S608, the content distribution server may transmit panoramic video data to terminal A, terminal B and the viewport sharing server, respectively, by means of RTP multicast, where the RTP packet includes timestamps and code data of the panoramic video. One panoramic video data frame may consist of one or more RTP packets.

At step S609, terminal B may supply viewport information thereof in real time, where the viewport information includes a pitch angle of the viewport, a yaw angle of the viewport, viewport owner information, and/or sharing flag information. The sharing flag may remain default and not be set at this time.

At step S610, the viewport sharing server may receive the viewport of terminal B, detect that the sharing flag is not set, display the viewport of terminal B by means of the renderer, and display a video within a viewport scope of terminal B after the viewport of terminal B is selected.

At step S611, terminal A may supply viewport information thereof in real time, where the viewport information includes a pitch angle of the viewport, a yaw angle of the viewport, viewport owner information, and/or sharing flag information. The sharing flag may remain default and not be set at this time.

At step S612, the viewport sharing server may receive the viewport of terminal A, detect that the sharing flag is not set, display the viewport of terminal A by means of the renderer, and display a video within a viewport scope of terminal A after the viewport of terminal A is selected.

At steps S613 through S614, the viewport sharing server may push viewport information thereof to terminal A and terminal B.

At steps S615 through S616, terminal A and terminal B may receive the viewport pushed by the viewport sharing server and display the viewport in a PIP mode or in a full screen mode.

At steps S617 through S618, terminal A and terminal B may disable their ports, respectively, and terminate the established session.

It should be appreciated by those skilled in the art that the above-mentioned steps shown in FIG. 6 are merely an exemplary embodiment where the viewport sharing server pushes viewport information thereof to terminal A and terminal B, and are not considered as a limitation to the present disclosure. For example, as for FIG. 6, steps S601 and S602 may be performed in reverse order, and steps S606, S607, and S608 may be performed concurrently.

According to the method for sharing a VR viewport provided in the above-mentioned exemplary embodiments of the present disclosure, an increased amount of information may be presented to the user, and thus the user experience may be improved significantly.

In addition to the above-mentioned exemplary embodiments of the system for sharing a VR viewport, the apparatus in the viewport sharing server for sharing a VR viewport, and the apparatus in the terminal for sharing a VR viewport in FIGS. 2 through 6, the present disclosure further provides exemplary embodiments of a method for sharing a VR viewport applicable to the system, a method for sharing a VR viewport applicable to the viewport sharing server, and a method for sharing a VR viewport applicable to the terminal.

The method for sharing a VR viewport applicable to the system may include: establishing, by a content distribution server, first transport connections to a terminal and a viewport sharing server, respectively, to multicast panoramic video data to the terminal and the viewport sharing server; establishing, by the viewport sharing server, the first transport connection to the content distribution server to receive the panoramic video data; establishing, by the viewport sharing server, a second transport connection to the terminal to receive viewport information supplied by the terminal or transmit viewport information to the terminal; rendering, by the viewport sharing server, the received viewport information; establishing, by the terminal, the first transport connection to the content distribution server to receive the panoramic video data; converting, by the terminal, the panoramic video data into video data within a user viewport scope; rendering, by the terminal, a video within the user viewport scope; establishing, by the terminal, the second transport connection to the viewport sharing server to supply the viewport information of the terminal and receive the viewport information transmitted from the viewport sharing server; converting, by the terminal, the panoramic video data into video data corresponding to the received viewport information; and rendering, by the terminal, a video corresponding to the received viewport information.

Optionally, supplying the viewport information of the terminal by the terminal may include : supplying by the terminal, viewport information indicating that sharing flag information in the viewport information has been set to a predetermined value (e.g., sharing is enabled) to the viewport sharing server if a user has set the sharing flag information to the predetermined value. In addition, transmitting viewport information to the terminal by the viewport sharing server may include: transmitting, by the viewport sharing server, viewport information indicating that the sharing flag information has been set to the predetermined value to a terminal in a network and allowing the terminal to receive the viewport information transmitted from the viewport sharing server in response to reception of the viewport information from the terminal.

Optionally, the method may further include: transmitting, by the terminal, a first request for acquiring the viewport information received by the viewport sharing server to the viewport sharing server and receiving only viewport information transmitted from the viewport sharing server (and no other viewport information) in response to the first request if a viewport sharing mode set by a user is a viewport tracking mode for the viewport sharing server; and transmitting, by the viewport sharing server, only the viewport information received by the viewport sharing server to the terminal in response to reception of the first request.

Optionally, the method may further include: transmitting, by the terminal, a second request for acquiring viewport information of a predetermined terminal to the viewport sharing server and receiving the viewport information of the predetermined terminal transmitted from the viewport sharing server in response to the second request if a viewport sharing mode set by a user is a viewport tracking mode for the predetermined terminal; and transmitting, by the viewport sharing server, the viewport information of the predetermined terminal to the terminal in response to reception of the second request.

Optionally, the method may further include: stopping, by the terminal, receiving the viewport information transmitted from the viewport sharing server if a viewport sharing mode set by a user is a DND mode.

Optionally, rendering, by the terminal, a video within the user viewport scope, and rendering, by the terminal, a video corresponding to the received viewport information may include : rendering, by the terminal, the video corresponding to the received viewport information in the rendered video within the user viewport scope, or rendering, by the terminal, the video within the user viewport scope in the rendered video corresponding to the received viewport information if a rendering mode set by a user is a PIP mode; or rendering, by the terminal, the video corresponding to the received viewport information in a full screen mode if a rendering mode set by a user is the full screen mode.

Optionally, transmitting, by the viewport sharing server, viewport information to the terminal may include: transmitting, by the viewport sharing server, the viewport information received by the viewport sharing server to a terminal in a network and allowing the terminal to receive the viewport information transmitted from the viewport sharing server in response to reception of a sharing operation.

Optionally, the method may further include: rendering, by the viewport sharing server, the video corresponding to the received viewport information based on the panoramic video data and the received viewport information; or rendering, by the viewport sharing server, the video corresponding to the received viewport information based on the panoramic video data and the received viewport information in response to reception of a selection operation to the received viewport information rendered by the viewport sharing server.

Optionally, the viewport information may include: a pitch angle of the viewport, a yaw angle of the viewport, sharing flag information, and viewport owner information.

It should be appreciated that the steps recorded in the above-mentioned method for sharing a VR viewport applicable to the system correspond to the terminals in the system described with reference to FIGS. 1 to 6, respectively. Therefore, the operations and features described for the terminals in FIGS. 1 to 6 are also applicable to the steps recorded in the above-mentioned the method for sharing a VR viewport, and thus will not be repeatedly described hereafter.

The method for sharing a VR viewport applicable to the viewport sharing server may include: establishing a first transport connection with a content distribution server; receiving, through the first transport connection, panoramic video data multicast by the content distribution server; establishing a second transport connection with a terminal; receiving, through the second transport connection, viewport information supplied by the terminal; transmitting, through the second transport connection, viewport information to the terminal; and rendering the received viewport information.

Optionally, transmitting, through the second transport connection, viewport information to the terminal may include: transmitting, through the second transport connection, viewport information indicating that sharing flag information has been set to a predetermined value (e.g., sharing is enabled) to a terminal in a network and allowing the terminal to receive the viewport information transmitted from a viewport sharing server in response to reception of the viewport information from the terminal.

Optionally, transmitting, through the second transport connection, viewport information to the terminal may include any one of the following: transmitting, in response to reception of a first request transmitted from the terminal, only the viewport information received by a viewport sharing server to the terminal through the second transport connection, wherein the first request is a request for acquiring the viewport information received by the viewport sharing server and is transmitted from the terminal to the viewport sharing server if a viewport sharing mode set by a user is a viewport tracking mode for the viewport sharing server; and transmitting, in response to reception of a second request transmitted from the terminal, viewport information of a predetermined terminal to the terminal through the second transport connection, wherein the second request is a request for acquiring the viewport information of the predetermined terminal and is transmitted from the terminal to the viewport sharing server if a viewport sharing mode set by a user is a viewport tracking mode for the predetermined terminal.

Optionally, transmitting, through the second transport connection, viewport information to the terminal may include: transmitting, through the second transport connection, the viewport information received by a viewport sharing server to a terminal in a network and allowing the terminal to receive the viewport information transmitted from the viewport sharing server in response to reception of a sharing operation.

Optionally, the method may further include: rendering a video corresponding to the received viewport information based on the panoramic video data and the received viewport information; or rendering, in response to reception of a selection operation to the rendered received viewport information, the video corresponding to the received viewport information based on the panoramic video data and the received viewport information.

It should be appreciated that the steps recorded in the above-mentioned method for sharing a VR viewport applicable to the viewport sharing server correspond to the modules in the viewport sharing server described with reference to FIGS. 2 and 3, respectively. Therefore, the operations and features described for the modules in FIGS. 2 and 3 may be also applicable to the steps recorded in the above-mentioned method for sharing a VR viewport applicable to the viewport sharing server, and thus will not be repeatedly described hereafter.

The method for sharing a VR viewport applicable to the terminal may include: establishing a first transport connection with a content distribution server; receiving panoramic video data through the first transport connection; converting the panoramic video data into video data within a user viewport scope, and rendering a video within the user viewport scope; establishing a second transport connection with a viewport sharing server; supplying viewport information of the terminal through the second transport connection; receiving viewport information transmitted from the viewport sharing server; converting the panoramic video data into video data corresponding to the received viewport information; and rendering a video corresponding to the received viewport information.

Optionally, supplying viewport information of the terminal through the second transport connection may include: supplying, through the second transport connection, viewport information indicating that sharing flag information in the viewport information has been set to a predetermined value to the viewport sharing server if a user has set the sharing flag information to the predetermined value.

Optionally, the method further may include: transmitting, through the second transport connection, a first request for acquiring the viewport information received by the viewport sharing server to the viewport sharing server and receiving the viewport information transmitted from the viewport sharing server in response to the first request if a viewport sharing mode set by a user is a viewport tracking mode for the viewport sharing server; or transmitting, through the second transport connection, a second request for acquiring viewport information of a predetermined terminal to the viewport sharing server and receiving the viewport information of the predetermined terminal transmitted from the viewport sharing server in response to the second request if a viewport sharing mode set by a user is a viewport tracking mode for the predetermined terminal.

Optionally, the method may further include: stopping, if a viewport sharing mode set by a user is a DND mode, receiving the viewport information transmitted from the viewport sharing server.

Optionally, the method may further include: rendering the video corresponding to the received viewport information in the rendered video within the user viewport scope, or rendering the video within the user viewport scope in the rendered video corresponding to the received viewport information if a rendering mode set by a user is a PIP mode; or rendering the video corresponding to the received viewport information in a full screen mode if a rendering mode set by a user is the full screen mode.

It should be appreciated that the steps recorded in the above-mentioned method for sharing a VR viewport applicable to the terminal correspond to the modules in the terminal described with reference to FIG. 2, respectively. Therefore, the operations and features described for the modules in the terminal of FIG. 2 are also applicable to the steps recorded in the above-mentioned method for sharing a VR viewport applicable to the terminal, and thus will not be repeatedly described here.

In the above-mentioned exemplary embodiments of the present disclosure, the first request and the second request merely represent two distinct requests. It should be appreciated by those skilled in the art that the terms “first” and “second” are not considered as a limitation to the request. The terms “first,” “second,” “third,” etc. are used herein to distinguish one entity from another entity, and they do not necessarily imply order or priority.

Likewise, in the above-mentioned exemplary embodiments of the present disclosure, the first transport connection and the second transport connection merely represent two distinct transport connections, where the first transport connection is a connection method suitable for multicasting panoramic video data, and the second transport connection is a connection method suitable for transmitting viewport information. It should be appreciated by those skilled in the art that the terms “first” and “second” are not considered as a limitation to the transport connection.

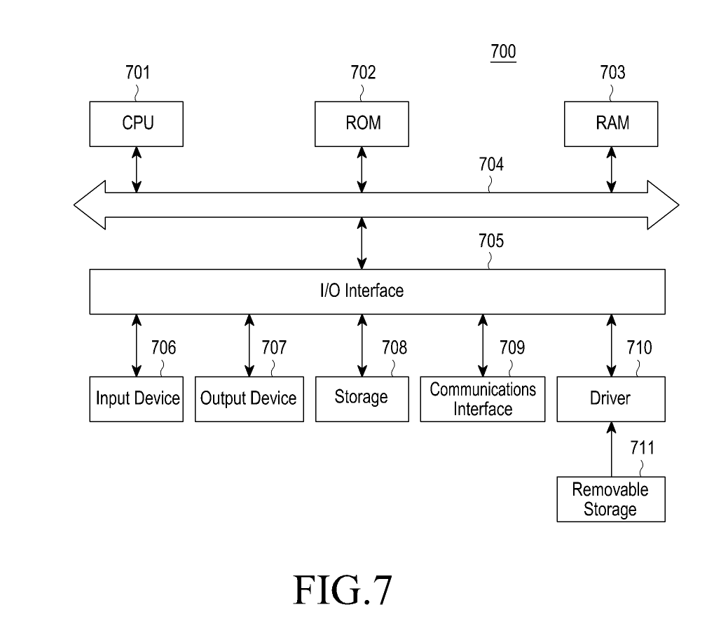

In FIG. 7, a schematic structural diagram of a computer system 700 adapted to implement a terminal device according to an exemplary embodiment is illustrated.

As shown in FIG. 7, the computer system 700 may include a central processing unit (CPU) 701, which may execute various actions and processes in accordance with a program stored in a read-only memory (ROM) 702 or a program loaded into a random access memory (RAM) 703 from a storage 708. The RAM 703 may also store various programs and data required by operations of the system 700. The CPU 701, the ROM 702, and the RAM 703 may be connected to each other through a bus 704. An input/output (I/O) interface 705 may also be connected to the bus 704.

The following components may be connected to the I/O interface 705: an input device 706 including a keyboard, etc.; an output device 707 including a cathode ray tube (CRT) display, a liquid crystal display (LCD) display, a speaker, etc.; storage 708 including a hard disk, etc.; and a communications interface 709 including a network interface card, such as an near-field communication (NFC) component, a LAN card, and a modem. The communications interface 709 may perform communication via a network, such as the Internet. Removable storage 711, such as a memory card, an external hard drive, etc., may also be connected to the I/O interface 705 through a driver 710.

In particular, according to an aspect of an exemplary embodiment, the process described above with reference to the flow chart may be implemented in a computer software program. For example, an exemplary embodiment may include a computer program product, which includes a computer program that is stored in a machine-readable medium. The computer program may include program code for executing the methods illustrated by the flow charts. In such an embodiment, the computer program may be downloaded and installed from a network via the communications interface 709.

The flow charts and block diagrams in the figures illustrate architectures, functions, and operations that may be implemented according to the system, the method and the computer program product of the various exemplary embodiments of the present invention. In this regard, each block in the flow charts and block diagrams may represent a module, a program segment, or a code block. The module, the program segment, or the code block may include one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and the combination of the blocks may be implemented by a dedicated hardware-based system executing specific functions or operations, or by a combination of a dedicated hardware and computer instructions.

The various units, modules, components, etc. involved in the various exemplary embodiments of the present disclosure may be implemented by way of software or hardware. The described units may also be provided in a processor, for example, described as: a processor, comprising a video receiver, a viewport receiver and a viewport transmitter, where the names of these units are not considered as a limitation to the units. For example, the video receiver may also be described as “a module for receiving, through a first transport connection, panoramic video data multicast by a content distribution server.”

In another aspect, the present disclosure further provides a nonvolatile computer-readable storage medium. The nonvolatile computer-readable storage medium may be the computer-readable storage medium included in the apparatus in the above-mentioned embodiments, or a stand-alone computer-readable storage medium which has not been assembled into the apparatus. The above-mentioned computer-readable storage medium stores one or more programs. The above-mentioned one or more programs may cause, when being executed by the above-mentioned device, a device to perform the following actions: establishing, by a content distribution server, first transport connections to a terminal and a viewport sharing server, respectively, to multicast panoramic video data to the terminal and the viewport sharing server; establishing, by the viewport sharing server, the first transport connection to the content distribution server to receive the panoramic video data; establishing, by the viewport sharing server, a second transport connection to the terminal to receive viewport information supplied by the terminal or transmit viewport information to the terminal; rendering, by the viewport sharing server, the received viewport information; establishing, by the terminal, the first transport connection to the content distribution server to receive the panoramic video data; converting, by the terminal, the panoramic video data into video data within a user viewport scope; rendering, by the terminal, a video within the user viewport scope; establishing, by the terminal, the second transport connection to the viewport sharing server to supply the viewport information of the terminal and receive the viewport information transmitted from the viewport sharing server; converting, by the terminal, the panoramic video data into video data corresponding to the received viewport information; and rendering, by the terminal, a video corresponding to the received viewport information.

The foregoing is only a description of exemplary embodiments of the present disclosure and the applied technical principles. It should be appreciated by those skilled in the art that the scope of the present disclosure is not limited to the technical solutions formed by the particular combinations of the above technical features. The scope should also cover other technical solutions formed by any combinations of the above technical features or equivalent features thereof without departing from the concept of the disclosure, such as, technical solutions formed by replacing the features as disclosed in the present disclosure with (but not limited to), technical features with similar functions. The word “exemplary” as used herein means “serving as an example or illustration.” Any aspect or design described herein as “exemplary” is not necessarily to be construed as preferred or advantageous over other aspects or designs. Moreover, claim language reciting “one of” a set or “at least one of” a set indicates that one member of the set or multiple members of the set satisfy the claim.

What is claimed is:

1. A method for sharing, by a viewport sharing server, a viewport in a viewport sharing system including content distribution server, viewport sharing server, and a plurality of terminals, the method comprising:
receiving panoramic video data multicast from the content distribution server;
receiving, from a first terminal, first viewport information generated by the first terminal;
transmitting, to a second terminal, the first viewport information;
transmitting, to a third terminal, a second viewport information generated by the viewport sharing server;
generating first video data, by rendering the panoramic video data based on the first viewport information; and
generating second video data, by rendering the panoramic video data based on the second viewport information,
wherein the first terminal, the second terminal and the third terminal, are configured to be included in the plurality of terminals.

2. The method of claim 1, further comprising:
establishing a first transmission connection with the content distribution server; and
establishing a second transmission connection with one of the plurality of terminals;
wherein the panoramic video data is received through the first transmission connection, and
wherein the first viewport information is transmitted or received through the second transmission connection, and
wherein the second viewport information is received through the second transmission connection.

3. The method of claim 1,
wherein the first viewport information includes pitch angle information, yaw angle information, view owner information, and sharing flag, and
wherein the second viewport information includes pitch angle information, yaw angle information, view owner information, and sharing flag.

4. The method of claim 1, further comprising:
receiving, from the third terminal, a first request to track the viewport of the viewport sharing server, and transmitting, to the third terminal, the second viewport information in response to the first request; and
receiving, from the second terminal, a second request to track the viewport of the first terminal, and transmitting, to the second terminal, the first viewport information in response to the second request.

5. The method of claim 1, further comprising:
transmitting the first video data to one of: the second terminal and the third terminal; and
transmitting the second video data, to one of: the first terminal, the second terminal and the third terminal.

6. A method for sharing, by a terminal, a viewport in a viewport sharing system including content distribution server, viewport sharing server, and a plurality of terminals, the method comprising:
receiving panoramic video data multicast from the content distribution server;
generating first viewport information;
transmitting, to the viewport sharing server, the first viewport information;
receiving, from the viewport sharing server, second viewport information;
generating first video data, by rendering the panoramic video data based on the first viewport information; and
generating second video data, by rendering the panoramic video data based on the second viewport information.

7. The method of claim 6, further comprising:
establishing a first transmission connection with the content distribution server; and
establishing a second transmission connection with the viewport sharing server;
wherein the panoramic video data is received through the first transmission connection, and
wherein the first viewport information is transmitted through the second transmission connection, and
wherein the second viewport information is received through the second transmission connection.

8. The method of claim 6,
wherein the first viewport information includes pitch angle information, yaw angle information, view owner information, and sharing flag, and
wherein the second viewport information includes pitch angle information, yaw angle information, view owner information, and sharing flag.

9. The method of claim 6, further comprising:
transmitting, to the viewport sharing server, a first request to track the viewport of the viewport sharing server, and receiving, from the viewport sharing server, the viewport information of the viewport sharing server corresponding to the first request; and
transmitting, to the viewport sharing server, a second request to track the viewport of another terminal, and receiving, from the viewport sharing server, the viewport information of the another terminal corresponding to the second request.

10. The method of claim 6, further comprising:
transmitting the first video data to the viewport sharing server; and
transmitting the second video data, to the viewport sharing server.

11. A apparatus for sharing a viewport, the apparatus comprising:
a first transceiver configured to receive panoramic video data multicast from a content distribution server;
a second transceiver configured to:
receive, from a first terminal, first viewport information generated by the first terminal,
transmit, to a second terminal, the first viewport information, and
transmit, to a third terminal, a second viewport information generated by the viewport sharing server; and
a controller including at least one processor and a memory, wherein the controller is coupled to the first transceiver and the second transceiver;
wherein the controller is configured to:
generate first video data, by rendering the panoramic video data based on the first viewport information, and
generate second video data, by rendering the panoramic video data based on the second viewport information,
wherein the first terminal, the second terminal and the third terminal, are configured to be included in the plurality of terminals.

12. The apparatus of claim 11,
wherein the first transceiver is further configured to:
establish a first transmission connection with the content distribution server, and receive the panoramic video data through the first transmission connection, and
wherein the second transceiver is further configured to:
establish a second transmission connection with one of the plurality of terminals,
receive the panoramic video data through the first transmission connection,
transmit or receive the first viewport information through the second transmission connection, and
receive the second viewport information through the second transmission connection.

13. The apparatus of claim 11,
wherein the first viewport information includes pitch angle information, yaw angle information, view owner information, and sharing flag, and
wherein the second viewport information includes pitch angle information, yaw angle information, view owner information, and sharing flag.

14. The apparatus of claim 11,
wherein the second transceiver is further configured to:
receive, from the third terminal, a first request to track the viewport of the viewport sharing server, and transmit, to the third terminal, the second viewport information in response to the first request; and
receive, from the second terminal, a second request to track the viewport of the first terminal, and transmit, to the second terminal, the first viewport information in response to the second request.

15. The apparatus of claim 11,
wherein the second transceiver is configured to:
transmit the first video data to to one of: the second terminal and the third terminal; and
transmit the second video data, to one of: the first terminal, the second terminal and the third terminal.

16. A apparatus for sharing a viewport, the apparatus comprising:
a first transceiver configured to receive panoramic video data multicast from a content distribution server;
a second transceiver configured to transmit, to the viewport sharing server, the first viewport information, and receive, from a viewport sharing server, second viewport information;
a controller including at least one processor and a memory wherein the controller is coupled to the first transceiver and the second transceiver;
wherein the controller is configured to:
generate first viewport information;
generate first video data, by rendering the panoramic video data based on the first viewport information; and
generate second video data, by rendering the panoramic video data based on the second viewport information.

17. The apparatus of claim 16,
wherein the first transceiver is further configured to:
establish a first transmission connection with the content distribution server; and
receive the panoramic video data through the first transmission connection, and
wherein the second transceiver is further configured to:
establish a second transmission connection with the viewport sharing server,
receive the panoramic video data through the first transmission connection,
transmit the first viewport information through the second transmission connection, and
receive the second viewport information through the second transmission connection.

18. The apparatus of claim 16,
wherein the first viewport information includes pitch angle information, yaw angle information, view owner information, and sharing flag, and
wherein the second viewport information includes pitch angle information, yaw angle information, view owner information, and sharing flag.

19. The apparatus of claim 16,
wherein the second transceiver is further configured to:
transmit, to the viewport sharing server, a first request to track the viewport of the viewport sharing server, and receiving, from the viewport sharing server, the viewport information of the viewport sharing server corresponding to the first request; and
transmit, to the viewport sharing server, a second request to track the viewport of another terminal, and receiving, from the viewport sharing server, the viewport information of the another terminal corresponding to the second request.

20. The apparatus of claim 16,
wherein the second transceiver is further configured to:
transmit the first video data to to the viewport sharing server; and
transmit the second video data, to the viewport sharing server.
